(19) United States
(12) Patent Application Publication
(10) Pub. No.: US 2012/0179443 A1
(43) Pub. Date: Jul. 12, 2012

(54) DYNAMIC GRID REFINEMENT

(75) Inventors: Diederik W. VAN BATENBURG, Rijswijk (NL); Paulus Maria BOERRIGTER, Rijswijk (NL); Jeroen Cornelis VINK, Houston, TX (US); Albert Hendrik DE ZWART, Mina Al Fahal (OM); Marco BOSCH, Rijswijk (NL)

(73) Assignee: SHELL OIL COMPANY, Houston, TX (US)

(21) Appl. No.: 13/325,218

(22) Filed: Dec. 14, 2011

Related U.S. Application Data
(60) Provisional application No. 61/423,886, filed on Dec. 16, 2010.

(51) Int. Cl. G06G 7/48

(52) U.S. Cl. 703/10

(57) ABSTRACT

A method for enhanced oil recovery, comprising selecting a target reservoir comprising hydrocarbons; inputting a plurality of parameters concerning the reservoir and the hydrocarbons into a simulator; and modeling an enhanced oil recovery technique with the simulator using dynamic local grid refinement to provide additional model resolution of a front between an enhanced oil recovery injectant and the hydrocarbons.

### PRIORITY CLAIM

The present application claims the benefit to priority of U.S. Provisional Application No. 61/423,886 entitled “Dynamic Grid Refinement” filed Dec. 16, 2010.

### FIELD OF THE INVENTION

The invention is directed towards systems and methods for modeling and then applying enhanced oil recovery (EOR) techniques.

### BACKGROUND

U.S. Patent Publication Number 2010/0027377 discloses methods to selectively excite and analyze the resonance phenomena existing in an enclosed oil, gas and or water reservoir, thereby locating its presence, by doing qualitative and quantitative estimates of its extent via forward modeling. The oil, gas or water reservoir is represented as a fluid filled crack system or as a fluid saturated sponge located in solid rock. This patent covers the actively excited response and details methods to optimize the excitation. Due to interaction between either fluid filled fractures or fluid saturated rock lenses and the surrounding rock, the incident seismic energy is amplified in specific frequency ranges corresponding to the resonance frequencies of such systems. Measurements are made over the survey area, singly or in arrays. These are first used to determine qualitatively the resonance behavior, by relating them to resonance signal sources and possibly their direction. Overall statistical analysis assesses dominant frequencies in the spectrum. H/V analysis excludes resonance effects in rock structures. Time windows are used in the frequency domain to help isolate oscillations in a cursory manner in the noise, which can then be refined to extract oscillation parameters more precisely with the Sompi method. Such found oscillations can then be related to oscillator properties from theoretical and numerical model simulations. A direction analysis with array measurements can be used to locate sources in the earth. Dimensions of the source are estimated via mapping techniques of strong signal areas. The influence of gas bubbles on the fluid velocity, expected to often present, enhances the impedance difference significantly, leading to a stronger resonance effect; to take this into consideration is an important part of this patent. A qualitative method in form of a numerical simulation using one of several specific physical concepts is used for further analysis. For instance the oscillation behavior is known from existing fluid dynamic research for cracks. A single or an assemblage of cracks can be used. For fluid saturated rock pillows with significant over-pressure there is a simplified theoretical model presented. Numerical models using Biot's theory for higher precision results represent a further example. By using a successive forward modeling/investigation with feedback, more details about the fluid saturated area below the surface are gained. It is also possible to determine the type of fluid present with the techniques of this patent. The physical properties of oil, water and gas affect the oscillating characteristics (frequency and Q value) of fluid filled fractures and fluid filled pillows enclosed in rock. These differences in the oscillations allow determining the type of fluid present. Specifically a qualitative survey method and a quantitative method based on a numerical modeling in conjunction with the Monte Carlo method are used to relate the oscillation characteristics to fluid properties. In the Monte Carlo method only fluid parameters are varied, while all other parameters are kept constant. There are specific dependencies on crack length in the case of cracks which needs to be properly estimated to obtain good results. We expect similar constraints for liquid filled pillows. The uniqueness of this method is that it is directly sensitive to the oil or gas itself, because the resonance effect is only present when a fluid is there. Non fluid related oscillations due to impedance differences have shear waves involved and can be excluded using H/V technique. In summary the patent uses techniques to relate the actual measurement with a numerical model based on specific physical concepts, and so arriving at relevant conclusions about the reservoir. U.S. Patent Publication Number 2010/0027377 is herein incorporated by reference in its entirety.

PCT Patent Publication WO 2009/155274 discloses a subterranean structure having fracture corridors, a model is used to represent the subterranean structure, where the model also provides a representation of the fracture corridors. A streamline simulation is performed using the model. PCT Patent Publication WO 2009/155274 is herein incorporated by reference in its entirety.

U.S. Patent Publication Number 2010/0217574 discloses a computer implemented system and method for parallel adaptive data partitioning on a reservoir simulation using an unstructured grid including a method of simulating a reservoir model which includes generating the reservoir model. The generated reservoir model is partitioned into multiple sets of different domains, each one corresponding to an efficient partition for a specific portion of the model. U.S. Patent Publication Number 2010/0217574 is herein incorporated by reference in its entirety.

There is a need in the art for one or more of the following:

Improved systems and methods for modeling petroleum reservoirs;

Improved systems and methods of designing, testing, and then using EOR processes with the use of a simulator;

Improved systems and methods for using a simulator to improve EOR flooding oil recovery;

Improved systems and methods for using a simulator to achieve higher resolution of an EOR front with a reduced computer processing load.

### SUMMARY OF THE INVENTION

One aspect of the invention provides a method for enhanced oil recovery, comprising selecting a target reservoir comprising hydrocarbons; inputting a plurality of parameters concerning the reservoir and the hydrocarbons into a simulator; and modeling an enhanced oil recovery technique with the simulator using dynamic local grid refinement to provide additional model resolution of a front between an enhanced oil recovery injectant and the hydrocarbons.

### BRIEF DESCRIPTION OF THE DRAWINGS

So that the features and advantages of the present invention can be understood in detail, a more particular description of the invention may be had by reference to the embodiments thereof that are illustrated in the appended drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts schematic diagrams showing a conventional time step sequence flow chart on the left and repeat time step flow chart on the right.

FIG. 2 is a graph depicting saturation profiles for different levels of refinement using an IMPES scheme.

FIG. 3 is a diagram depicting the evolution of saturation distribution and grid adaption steps in an implicit mode during a time step of 100 days.

FIG. 4 is a graph depicting saturation profiles and scaled saturation derivatives for previous and next time steps.

FIG. 5 is a graph depicting saturation profiles on a globally fine grid and a grid with dynamic refinements, where the different curves show the effect of reducing the time step size.

FIG. 6 provides two graph and diagram combinations showing saturation and polymer concentration profiles using DLGR, where the left graph and diagram shows saturation and polymer concentration profiles using DLGR driven by concentration gradients and the right graph and diagram shows saturation and polymer concentration profiles using DLGR driven by saturation gradients, with the highest water saturation is to the left of each diagram and the highest polymer concentration is to the right of each diagram.

FIG. 7 is a graph and diagram combination showing saturation and polymer concentration profiles using DLGR driven by concentration and saturation gradients, where the highest water saturation is to the left of the diagram and the highest polymer concentration is to the right of the diagram.

FIG. 8 is a graph showing the change in coke mass during a time step, the gradient of which is used to drive DLGR for ISC.

FIG. 9 is a graph showing temperature distribution and grid refinement at four times after the start of air injection.

FIG. 10. is a graph showing the evolution of temperature in time for DLGR driven by temperature gradient.

FIG. 11 is a three dimensional grid showing the saturation distribution at the end of a gas injection cycle for a two level DLGR case.

FIG. 12 is a graph showing the predicted GOR and number of grid blocks for base run and DLGR runs with 1 and 2 levels of refinement.

### DETAILED DESCRIPTION

Presently preferred embodiments of the invention are described in detail below.

Most recovery processes have fluid banks and/or fronts moving in the reservoir. The accurate representation of these processes requires a description at a scale much smaller than typical grid block sizes used in black-oil reservoir simulations. In addition, an accurate description of these processes requires extra components, sometimes requires additional phases, sometimes requires the capability to model thermal properties, and in some instances even requires the capability to model chemical reactions between components. Simulation of these processes on a fine scale grid throughout a reservoir or even in a small pattern is not practical, as this rapidly becomes too CPU and memory intensive. Dynamic Local Grid Refinement (DLGR) offers a solution for this problem: simulations can start from a relatively course grid that is dynamically adjusted to provide sufficient spatial resolution to accurately follow thermal and/or displacement front(s).

A nested Dynamic Local Grid Refinement system is capable of determining dynamically a refined grid in an implicit simulation mode, i.e. it determines the refinements there where the fronts will be at the end of a simulation timestep in an automatic way.

This implicit local grid refining is achieved by extending the monitor functionality to the Newton-Raphson solution level: it is now possible to change any property, defined at input level, not only at timesteps but also during the Newton-Raphson process. This is a very general scheme with potential application outside dynamic gridding (application of formulations not available in the simulator, coupling to other programs, etc).

For the dynamic gridding application, a timestep starts from the existing grid. On this grid the Newton process is applied to solve the equations associated with the next time level. Once the Newton process is converged, the grid is refined or coarsened based on some criteria and the Newton process is continued until again convergence is obtained. This next set of Newton steps uses starting values of the primary variables that are based on the values calculated in the previous Newton cycle, but interpolated/amalgated to the new grid. After convergence a further level of refinement can be applied in the same way.

This scheme is a kind of semi-implicit method and does not have overall quadratic convergence anymore. However, the main non-linearity's due to the time-advance of fronts, are being dealt with in the first Newton-Raphson cycle. Refining and coarsening a grid at the new front positions (at the end of the time step) using the start values derived from the results of the previous cycle is in general a more linear problem needing a limited number of Newton Raphson iterations.

One possible advantage of this scheme is that refinements only occur there where the actual fronts will go. No assumptions have to be made before hand on where fronts move. This makes application simpler and also allows strict control on the number of grid blocks by minimizing the width of the refined zone. The latter is of particular importance for nested refinements as the number of grid blocks rapidly grows with deeper levels of refinement.

Application of dynamic local grid refinement ranges from normal waterflooding problems (in large fields) to EOR applications like chemical flooding, solvent flooding, steam flooding and in situ combustion.

From a conceptual level three capabilities are required for dynamic gridding: (1) refinement, (2) coarsening, and (3) identification where and when to refine or coarsen. Refine capabilities are available in many commercial reservoir simulators. Local coarsening is also available in several reservoir simulators. The main challenge in developing a practical DLGR-technique appears to be in establishing ways to identify where and when to refine and coarsen. This requires a robust set of criteria for refining or coarsening and, more importantly, an efficient way to evaluate whether or not a particular grid block fits these criteria. In fact, having a proper grid at the end of a time step could be considered as an additional condition for the completion of a time step, next to numerical convergence and honouring well constraints.

It is generally difficult to judge at the start of a time step where fronts and fluid banks will be at the end of the time step, as this is essentially the problem that the reservoir simulator has to solve. With an implicit scheme, time steps can be large and fronts may move through multiple grid blocks, making their location difficult to extrapolate. The Newton-Raphson (NR)-process is, due to its quadratic convergence behavior, an efficient algorithm to solve implicit reservoir simulation equations on a fixed grid. This method, however, is not suitable for calculating adaptations in the grid needed to capture moving fronts, as it is not clear how to calculate derivatives with respect to adapting grids.

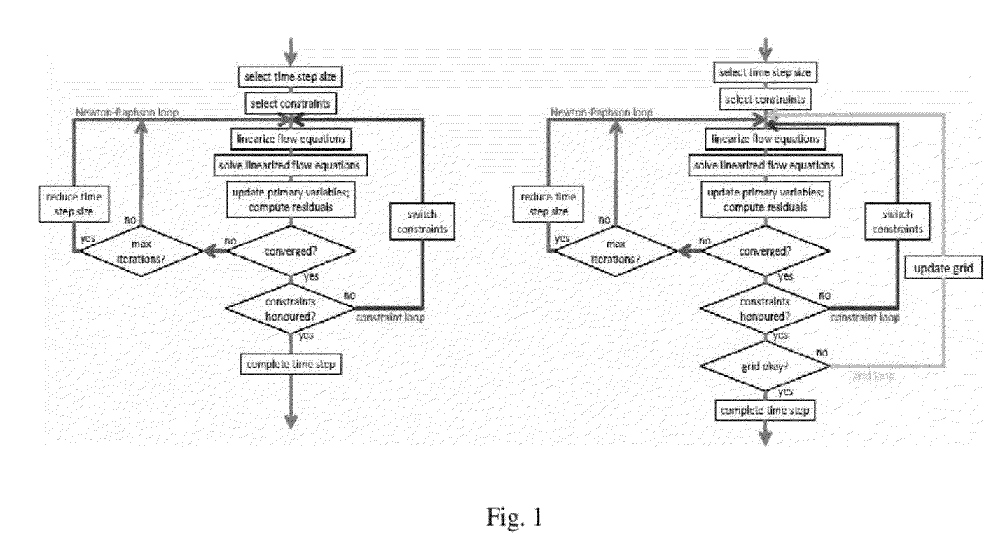

Therefore, to implement DLGR for an implicit solution mode we use a semi-implicit approach: the reservoir simulation equations are first solved with a NR-process on a fixed grid, after which the grid is adapted. To solve the equations on the updated grid, the NR-process is continued with start values taken from interpolated or amalgamated values from the previous grid. This choice of start values ensures that the whole process is still efficient as the largest non-linearities occur in the first NR-process where the effects of progressing time by one time step are estimated. This first step calculates where fronts are going to be and gives an accurate average front position. The follow up NR-processes, in which the grid is refined or coarsened, use the estimated front position as start value and mainly have the effect of sharpening the front. This sharpening turns out to be a much more linear process than the displacement calculated during the first NR-process of a time step and usually only a few additional NR steps are needed to get an accurate solution for the modified grid. The concept is illustrated in FIG. 1 and has the following characteristics:
The refined grid is determined dynamically in an implicit simulation mode. The refinements are automatically positioned to where the fronts will be at the end of a time step. This is a robust technique that does not require assumptions regarding the propagation of the fronts and can be used for any recovery scheme.
Fronts are described with a minimum number of blocks in the refined zones. This is particularly important for nested refinements as the number of blocks rapidly grows with extra refinement levels.
In addition to gradients in space, property gradients in time can be used to determine where refinement or coarsening have to occur. Second order derivatives are not generally available to detect changes, but in the implementation of the method proposed here, an estimate of the mixed second order space-time derivative consisting of the spatial changes of grid block time derivatives is directly available. This second order space-time derivative is often a very good indicator of shock positions.
Only discretization errors in space are reduced. Errors due to finite time step still remain. The effect of these errors are best determined by running sensitivities. The error allowed due to time step size selection provides a limit to the number of spatial nested refinement levels that is still useful. The time discretization analog of DLGR would be local time stepping—this would require additional simulator enhancements.

This DLGR-method was implemented in Shell's in-house Modular Reservoir Simulator (MoReS). The modular structure of this simulator coupled with the extensive control and scripting possibilities allowed for an efficient implementation of the functionality. Full access exists at the user level to all properties within a time step, including access to spatial, time and mixed space-time derivatives. This flexibility together with a so-called “monitor” control mechanism, through which the user can modify and adjust the simulation model during time-stepping, allows appropriate refinement rules to be established for any recovery process.

TABLE 2
Dimensions and other relevant data for 1-D oil water displacement
example.

| Property | Unit | Model | Oil | Water |
|---|---|---|---|---|
| Length | [ml] | 100 | | |
| Width, height | [m] | 10 | | |
| Porosity | [—] | 0.30 | | |
| Permeability | [mD] | 100 | | |
| Viscosity | [cp] | | 2.0 | 0.5 |
| Immobile saturation | [—] | | 0.20 | 0.15 |
| Endpoint relative permeability | [—] | | 1.0 | 0.30 |
| Corey exponent | [—] | | 2.0 | 4.0 |

### Application

In this section we show several applications of implicit nested DLGR. We first illustrate the characteristics of the method by applying it to a 1-D Buckley-Leverett water-oil displacement front. We then illustrate the importance of choosing appropriate refinement criteria to resolve the different fronts that may occur in EOR-processes in a 1-D polymer flood and 2-D in situ combustion example. We conclude with a 3-D field model example with application to immiscible Water Alternating Gas injection (WAG), where we also discuss the performance of the method.

### One-Dimensional Water-Oil Displacement

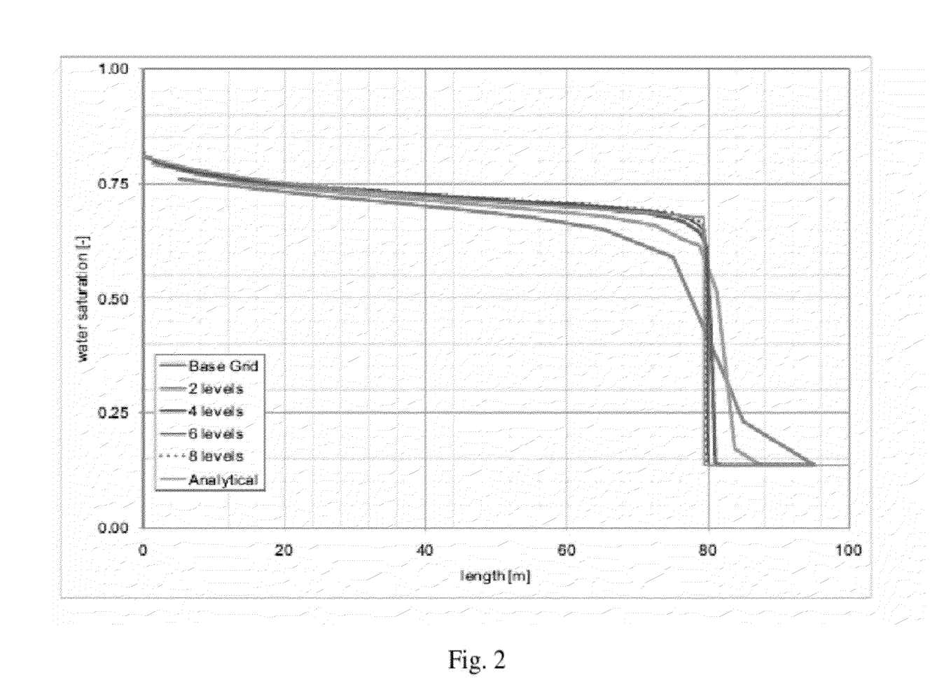

A 1-D water-oil displacement is a hyperbolic problem that generally does not require a fully implicit solution scheme, as IMPES solution schemes work very well. For comparison with implicit DLGR we first apply DLGR in IMPES mode to this 1-D problem. The dimensions of the system and other relevant data are listed in Table 2. Applying a nested dynamic refinement scheme in IMPES-mode requires time step sizes to be reduced if more levels of refinement are allowed, as the smallest grid blocks determine the stable CFL-condition. FIG. 2 and Table 3 show that a Buckley-Leverett shock-front can be accurately and efficiently captured by increasing the number of refinement levels. The potential of DLGR is demonstrated by the number of grid blocks required: only 85 dynamic blocks for the finest grid while a full fine run would require 2560 blocks. The number of time steps, however, rapidly increases with the increasing levels of refinement.

TABLE 3
Grid block dimensions, maximum stable (IMPES) time steps and
total number of time steps for results shown in FIG. 2.

| | max | min | | | time | |
|---|---|---|---|---|---|---|
| | size | size | | | step | # |
| | [m] | [m] | fine | DLGR | [hr] | steps |
| base grid | 10.00 | 10.000 | 10 | | 40.00 | 52 |
| 2 levels | 10.00 | 2.500 | 40 | 18 | 10.00 | 152 |
| 4 levels | 10.00 | 0.625 | 160 | 30 | 2.50 | 671 |
| 6 levels | 10.00 | 0.156 | 640 | 55 | 0.63 | 2904 |
| 8 levels | 10.00 | 0.039 | 2560 | 85 | 0.16 | 12230 |

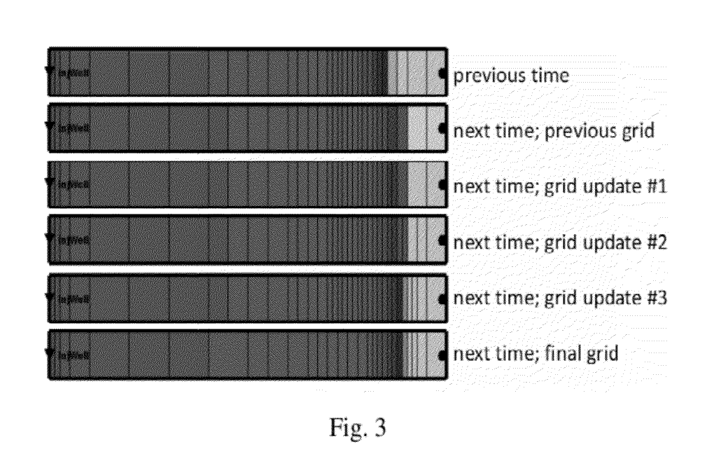

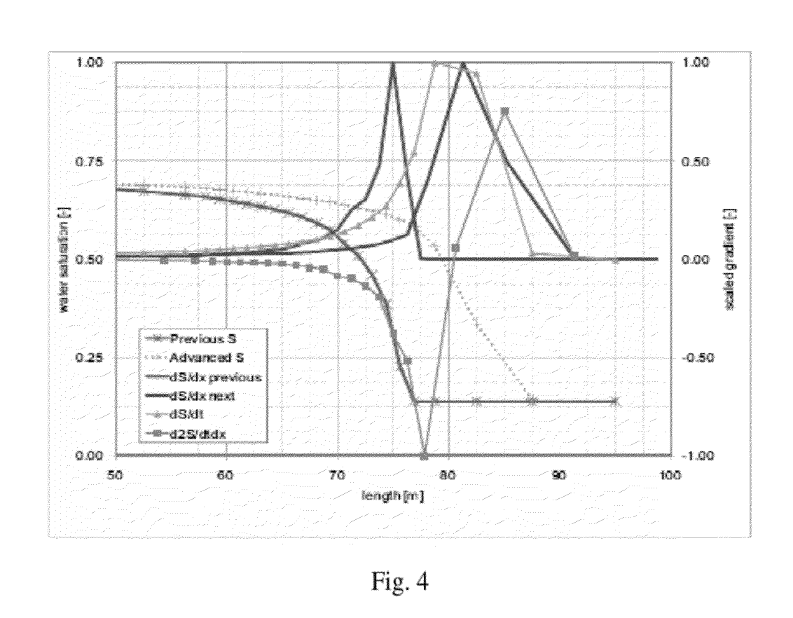

FIG. 3 shows the evolution of the oil-water saturation front calculated with the implicit DLGR method. In implicit mode, stability conditions do not pose restrictions on the time step size. For illustration purposes we choose a large time step of 100 days, during which the front moves through several (coarse) grid blocks. FIG. 4 shows the front at a specific, current, time (asterix), and the front calculated at the same grid but one time-step advanced together with different gradients available for determining the front position and, based on this, grid blocks to be refined and coarsened. The spatial gradient at the current position is clearly of no relevance for determining the new front position. Changes in the spatial gradient at the new time level, the time gradient, i.e the difference of saturation in a grid block between new and current time divided by the time step size, and the mixed second order derivative which is the spatial gradient of the time gradient all coincide with the front position. In particular the latter has a clear signature (maximum and sign change) at the actual front position. Any of these three gradients can be used as criterium to refine the grid at the new front position and coarsen blocks at the old front position. To solve the reservoir equation on the updated grid, the NR-process is continued on with start values taken from interpolated or amalgamated values from the original grid. As can be seen in FIG. 3 the effect of this grid-adaption and subsequent solution is a sharpening of the front; the actual front position is hardly changing.

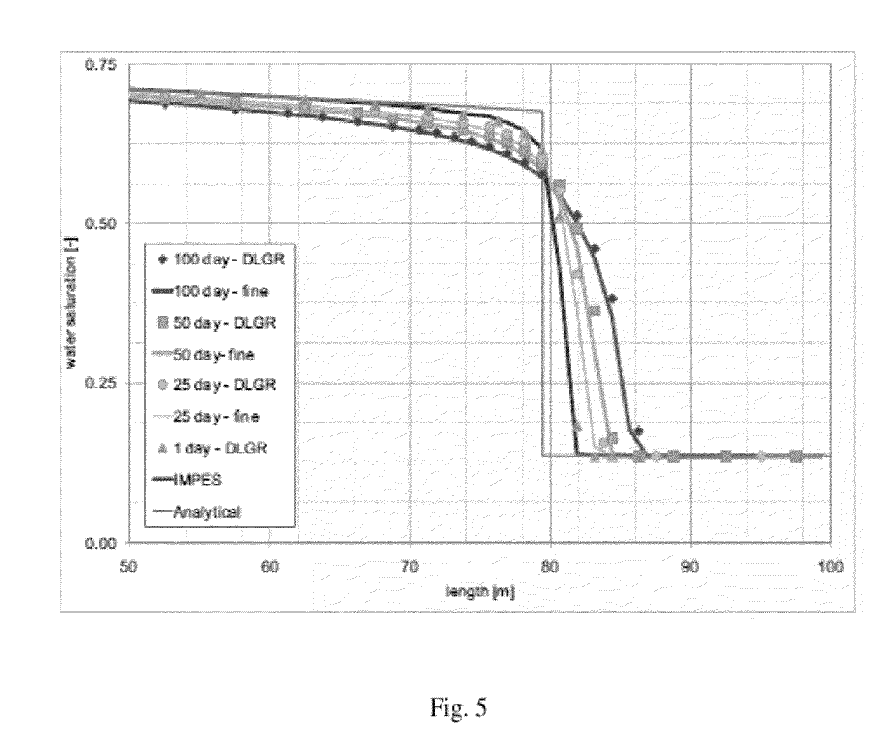

In the example shown in FIG. 3, DLGR results in a sharpening of the front, however, the amount of sharpening obtained even with three levels of refinement is limited. The best profile still shows significant numerical dispersion due to the large time step size used. DLGR only reduces the spatial gridding error, not the discretisation error introduced by taking large discrete time steps. However, the obtained solution is in good agreement with the one obtained on an entirely refined grid with the same time step size, as shown in FIG. 5. Apparently, the spatial discretization error of the DLGR-grid is determined by the size of the smallest grid blocks. To get a sharper profile, the time step size also needs to be reduced. FIG. 5 shows how the front sharpens if, in addition to DLGR, also the time step size is reduced. Results comparable with the resolution obtained in the IMPES example of FIG. 2 are only obtained for small time step sizes. For a given time step size, only a limited number of nested spatial refinements will have an effect. As soon as the time discretization error is the dominating error, further improvement in spatial resolution is no longer effective. The self sharpening nature of a non-linear Buckley-Leverett water-oil shock tends to suppress numerical dispersion in water flooding simulations and allows for reasonably sized time steps. For diffusive problems numerical dispersion is much more severe and will require, in addition to nested refinement, small time step sizes to obtain accurate solutions.

### Linear Polymer Flood

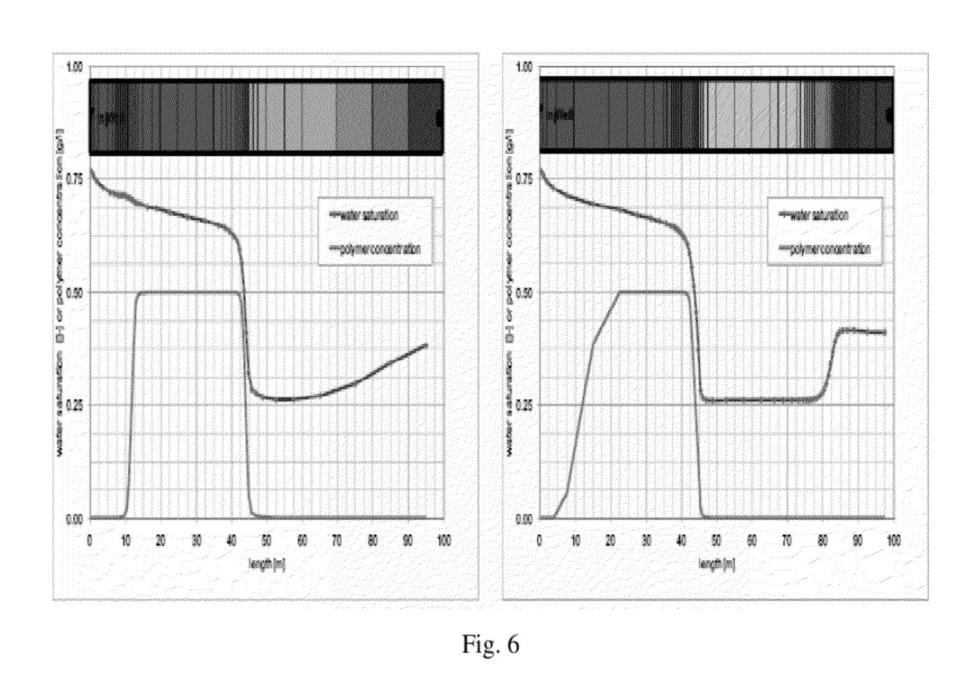

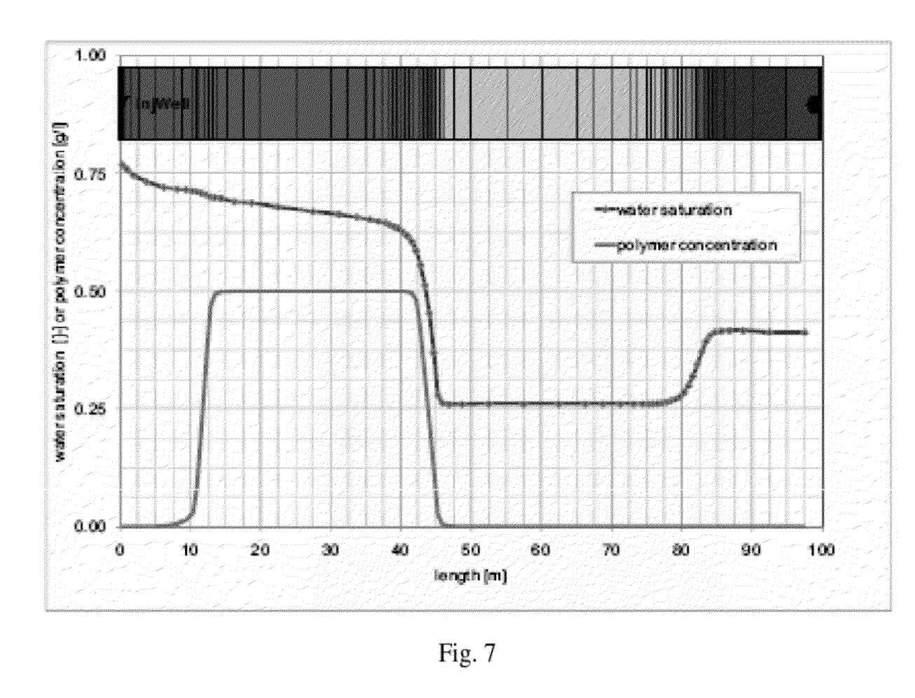

In this example we illustrate the importance of selecting the right criteria to drive the DLGR. The model used is similar to the oil-water displacement of the previous example. A bank of polymer solution chased by water is injected following the injection of one pore volume of water. For an accurate simulation of a polymer flood it is important that the viscosity of the polymer solution is properly represented. As the viscosity is a function of the polymer concentration, it seems logical to use the concentration gradient as criterion for DLGR. Alternatively, the saturation gradient used in the previous example, could also be applied here. Results that use the concentration gradient as criterion are shown in left graph of FIG. 6 while results that use saturation gradient as criterion are shown on the right. The front of the polymer bank where it meets the backside of the oil bank, is nicely captured by both approaches. The simulation based on the concentration-gradient criteria also captures the backside of the polymer bank while this interface gets smeared out in the coarse grid blocks in the saturation gradient based description. However, only the saturation gradient based simulation is able to capture the front side of the oil bank. To capture all features of the polymer flood correctly, both criteria should be used, as shown in FIG. 7. The process dependent criteria for refinement can be tuned and adapted using the scripting and monitor functionality that is available in MoReS. This also allows for the combination of criteria, such that all relevant process details can be captured and followed dynamically.

TABLE 4
Properties of the base grid used for the ISC example.

| | | | | | | |
|---|---|---|---|---|---|---|
| Coarse grid dimensions, I, J, K | [—] | 30 | 1 | 25 | | |
| Base block length | [m] | 10 | | | | |
| Base block width | [m] | 2 | | | | |
| Block height | [m] | 4 | 8 | 16 | 64 | 128 |
| Number of blocks in z- | [—] | 11 | 4 | 4 | 2 | 4 |
| direction | | | | | | |

### In-Situ Combustion (ISC) in Cross-Section

ISC is a displacement process in which a combustion front propagates through the unburned zones of a reservoir to increase oil production by delivering a steam and flu gas drive, and by reducing the viscosity of the heated and cracked oil. Injected air provides drive energy and delivers oxygen to burn the oil. The small scale and local nature of combustion reactions forces up-scaling of reaction kinetics in numerical simulations. Typically, combustion tube (CT) experiments show burn front features on a cm-scale. The grid block size in sector models is at least two orders of magnitude larger, i.e. 1-10 meters. Maintaining the same kinetic parameters derived from history matching CT-experiments, results in a phenomenon called block burnout. Smearing of the combustion front is due to averaged temperatures in the large grid blocks that are much lower than the temperatures at the combustion front. The reaction rate is therefore much lower and reactions die out.

For this reason, numerical models for ISC are excellent candidates for DLGR. DLGR allows for drastic refinement of the grid near the combustion front, providing suitable gradients to position the grid refinements, i.e. temperature or reaction rates. Using DLGR in combustion simulations enables the simulator to compute the combustion process on a much finer scale with more realistic temperatures and reaction kinetics. Dynamic gridding has the potential to locally bring the resolution down to the (sub) meter scale, even in field-scale models. Christensen already demonstrated the benefit of using DLGR for ISC simulations.

The example applies our semi-implicit DLGR method to an ISC-model presented earlier, with a few changes:
Use of a single reaction: Coke+O2=) COx+H2O+Heat (High Temperature Oxidation)
Fuel (coke) is initially present in the oil column (based on the experimentally obtained fuel deposition),
Crude is described by single component oil (possible due to adopting a single reaction model)
Temperature dependent reaction rate (Arrhenius type reaction)
Gas override effects are taken into account by extending the model in the horizontal direction (Table 4 shows the dimensions).

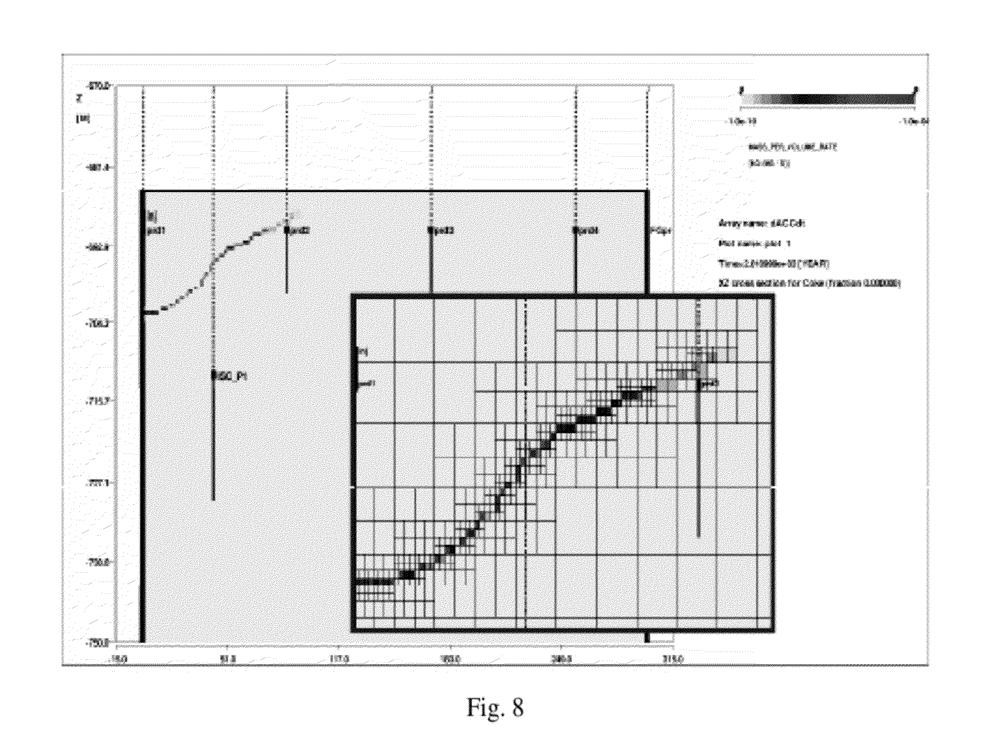

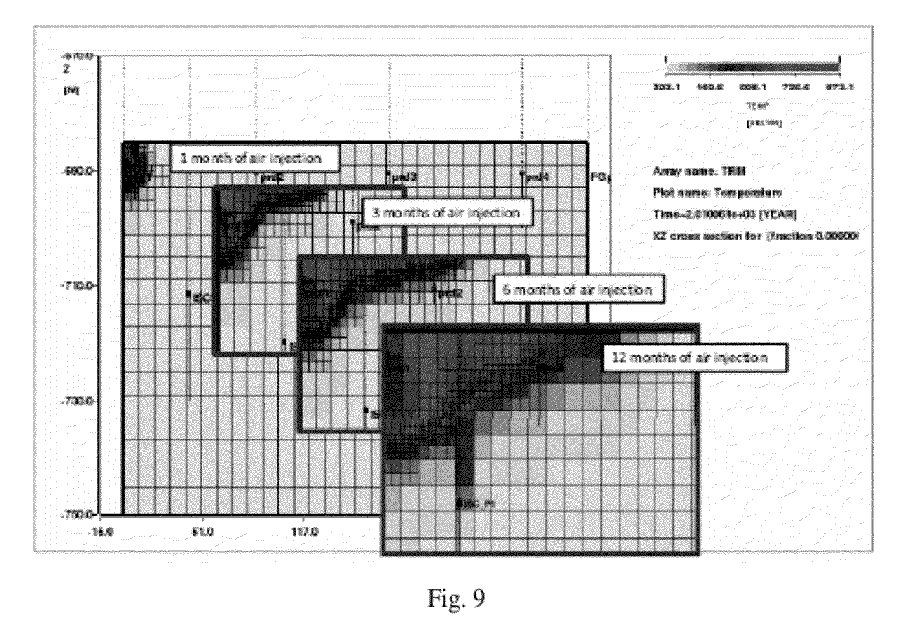

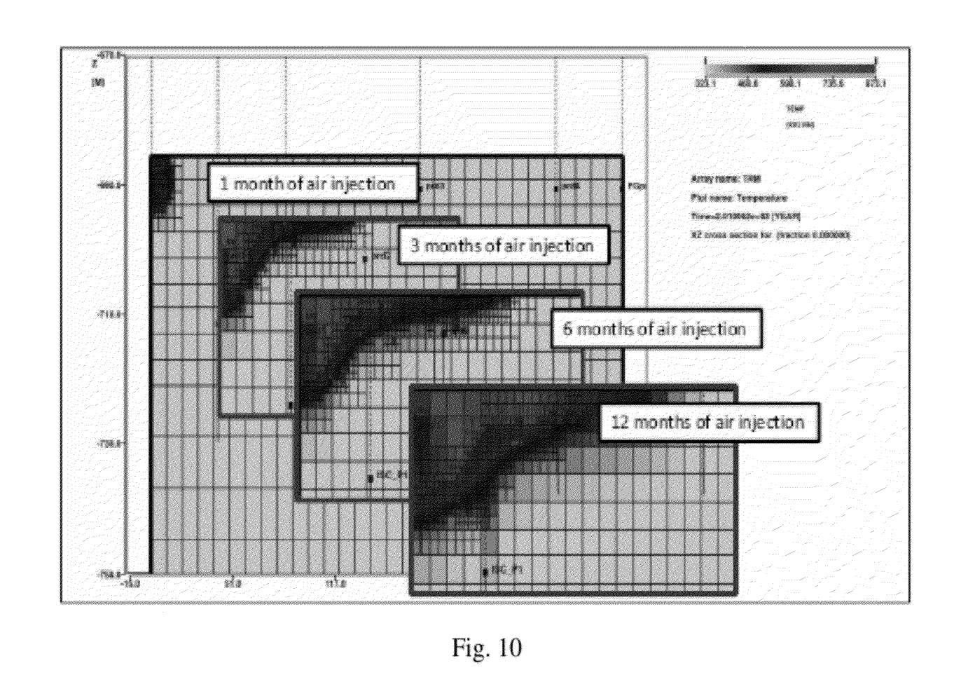

As discussed before, a compelling benefit of using a nested DLGR is that the dimension of the grid blocks at the finest level can approach the sub-meter scale, while the coarse grid blocks in the majority of the model can be tens of meters in size. The key enabler for correctly and robustly positioning the nested refinements along the propagating combustion front is to select the right refinement criteria. It is then possible to only refine the grid in those grid blocks where the combustion reactions actually take place. In the example the time-space mixed second order derivative of component mass accumulation was used as a refinement criterion. This property captures mass changes and gradients due to the both combustion reaction and displacement. This criterion gives an excellent indication of the locations where the coke combustion reactions occur as illustrated in FIG. 8. The large scale picture provides an indication of the small area where the reactions occur while the close-up shows the front together with the nested grid around the combustion front. FIG. 9 shows the evolution of the temperature and DLGR-evolution at four different times. The refinement criterion appears to work well and results in a small area with refinements along the combustion front. Using the temperature gradient as the refinement criterion leads to a wider refined grid region because the generated hot gasses travel much faster than the combustion front. The temperature gradient based DLGR grids, as shown in FIG. 10, have a larger number of unnecessarily refined grid blocks at locations where reactions do not occur.

### Water Alternating Immiscible Gas (WAG) Injection in Field Scale Model

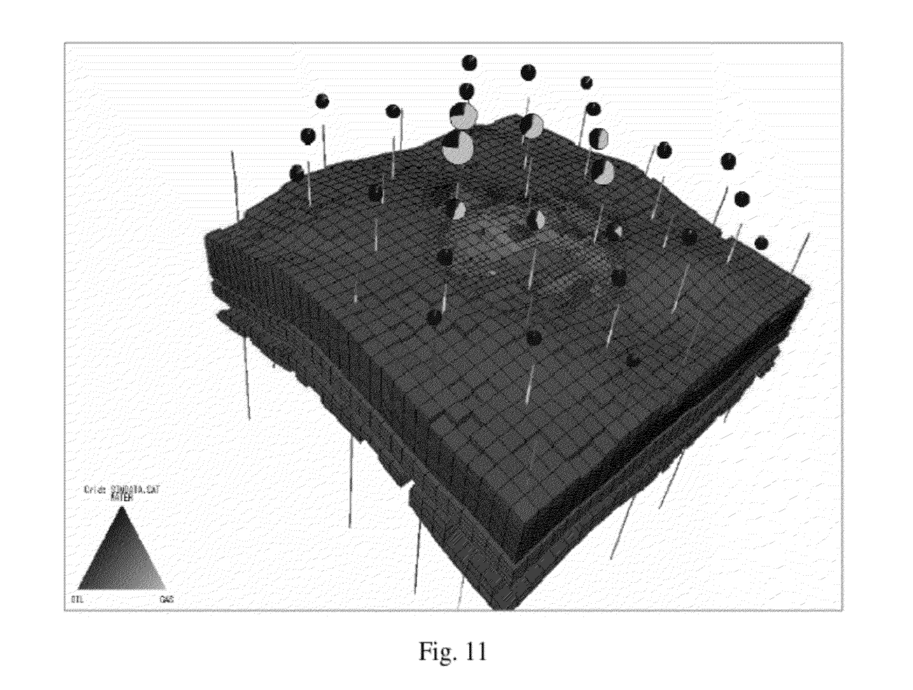

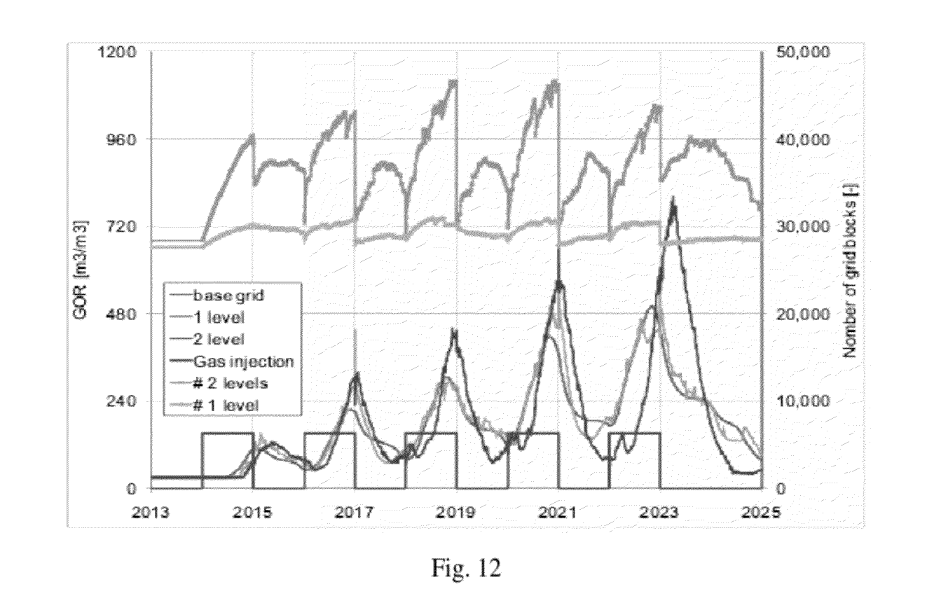

This last example serves to illustrate that the proposed method can also be used in field scale models with corner point grids based on geological models. The example uses a sector from a larger model; it has 31 blocks in both horizontal directions and contains 35 layers. At the start of gas injection there are 38 active producers and 12 active injectors arranged in 9-spot patterns. The field has been developed with water injection as a IOR-process. Immiscible WAG injection is evaluated as a EOR-process to recover oil by-passed by the injected water. A 9-component Equation Of State (EOS) description is used to capture the phase behaviour of the oil with the injected gas. In order to evaluate the grid sensitivity of the WAG-process, simulations were conducted on the base grid and on grids with one and two levels of DLGR. Characteristics of the different grids used are given in Table 5. FIG. 11 shows a 3-D view of the saturation distribution at the end of a gas injection cycle for the two level DLGR case. Gas is injected in the injector at the center of the model. The time-space mixed second order derivative of the gas saturation is used to track the fronts. The 3-D view shows that this criterion appears to work well as it is able to track the gas front from the injector to its current position. This is also illustrated in FIG. 12, which shows the number of grid block versus time for DLGR-simulations with one and two levels of refinement, the gas injection cycles versus time, and the resulting GOR for the various grids used. The DLGR-case with two levels of refinement results in later gas breakthrough and higher maximum predicted GOR due to the reduced the numerical dispersion. For both DLGR cases the number of grid blocks increases during each gas injecting period as the radius of the gas invaded area around the injector increases. The number of grid blocks decreases at the end of a gas injection period as the free gas is produced or becomes immobile, and no additional gas is supplied. In the subsequent water injection period the number of grid blocks again increases as the water sweeps-up some of the previously immobile gas towards the producers. In this way five gas fronts and five water fronts, all tracked by the DLGR method, are moving through the model during the simulated time period.

TABLE 5
Grid properties and performance of semi-implicit DLGR in the different
WAG simulations.

| | | | | maximum | relative |
|---|---|---|---|---|---|
| | nx | ny | nz | blocks | performance |
| Base grid dimensions | 31 | 31 | 35 | 27567 | 1.00 |
| LGR 1 level - refinement pattern | 2 | 2 | 1 | 86586 | 5.87 |
| DLGR 1 level - refinement | 2 | 2 | 1 | 30984 | 1.54 |
| pattern | | | | | |
| DLGR 2 level - effective | 4 | 4 | 1 | 46731 | 4.07 |
| refinement pattern | | | | | |

The relative performance of the DLGR models in comparison to the base model are also shown in Table 5. A simulation was also conducted with a model in which 25 of the layers had one level of refinement (LGR 1 level). A similar simulation with two levels of global refinement of these 25 layers, which leads to about 320,000 grid blocks, was not considered practical due to the large number of grid blocks and components. Note that the two-level DLGR simulation model runs significantly faster than the one-level globally refined model.

### Discussion

The examples in the previous section illustrate the characteristics and the versatility of the proposed DLGR method. The ability to evaluate properties during a time step, enables using criteria for refinement that are based on the position of a front at the next time step level without the need for assumptions made before hand on where fronts will move. This makes application DLGR simple and robust and in combination with multi-level refinements, it also allows for a tight control on the number of grid blocks by minimizing the size of the refined zone(s). The latter is of particular importance when the refined grid blocks must be orders of magnitude smaller than the coarse blocks of the base model, as was shown in the 2-D ISC example.

The examples also show that different processes may require different refinement criteria. The process dependent refinement criteria can be tuned and adapted using the scripting and monitor functionality that is available in Shell's in-house simulator, MoReS. This also allows for the combination of different criteria, such that all required process details can be captured and followed dynamically. This functionality allows for the evaluation of the mixed time-space second order derivative of any property that has a clear signature with a pronounced maximum and sign change and has been successfully used in the examples presented above.

The potential disadvantage of the proposed DLGR method is the additional NR-iterations that are required to complete a time step after the grid has been adapted. However, we found that only a few iterations are needed if the NR-process is continued, to adapt the solution to the modified grid. The 3-D WAG cases clearly illustrate that it is more efficient to use one-level DLGR than full one-level LGR. In addition, the two-level DLGR model can provide higher resolution results for relatively large models with a significant number of components within the time it takes to complete a full one-level LGR simulation.

Potential application of the proposed DLGR-scheme ranges from normal water flooding problems in large fields models, to EOR applications like low salinity water flooding, chemical flooding, steam flooding, solvent injection and in-situ combustion. DLGR, however, only reduces the spatial discretization error; for a given time step size, only a limited number of nested spatial refinements will have an effect. As soon as the time discretization error is the dominating error, further improvement in spatial resolution is no longer effective.

### Illustrative Embodiments

In one embodiment, there is disclosed a method for enhanced oil recovery, comprising selecting a target reservoir comprising hydrocarbons; inputting a plurality of parameters concerning the reservoir and the hydrocarbons into a simulator; and modeling an enhanced oil recovery technique with the simulator using dynamic local grid refinement to provide additional model resolution of a front between an enhanced oil recovery injectant and the hydrocarbons. In some embodiments, the method also includes applying the enhanced oil recovery technique to the reservoir to produce at least a portion of the hydrocarbons. In some embodiments, the method also includes modeling a plurality of variations of the enhanced oil recovery technique with the simulator. In some embodiments, the method also includes modeling a plurality of enhanced oil recovery techniques with the simulator. In some embodiments, the enhanced oil recovery technique is selected from the group consisting of a water flood, a low salinity water flood, a polymer flood, a surfactant flood, a gas flood, an ASP flood, a solvent flood, a steam flood, a fire flood, and/or combinations of one or more of the listed techniques.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What we claim is:

1. A method for enhanced oil recovery, comprising:
selecting a target reservoir comprising hydrocarbons;
inputting a plurality of parameters concerning the reservoir and the hydrocarbons into a simulator; and
modeling an enhanced oil recovery technique with the simulator using dynamic local grid refinement to provide additional model resolution of a front between an enhanced oil recovery injectant and the hydrocarbons.

2. The method system of claim 1, further comprising applying the enhanced oil recovery technique to the reservoir to produce at least a portion of the hydrocarbons.

3. The method of claim 1, further comprising modeling a plurality of variations of the enhanced oil recovery technique with the simulator.

4. The method of claim 1, further comprising modeling a plurality of enhanced oil recovery techniques with the simulator.

5. The method of claim 1, wherein the enhanced oil recovery technique is selected from the group consisting of a water flood, a low salinity water flood, a polymer flood, a surfactant flood, a gas flood, an ASP flood, a solvent flood, a steam flood, a fire flood, and/or combinations of one or more of the listed techniques.
